(19) United States
(12) Patent Application Publication
(10) Pub. No.: US 2006/0288462 A1
(43) Pub. Date: Dec. 28, 2006

(54) Garments composed of fabric panels incorporating edible cells

(76) Inventor: Yvonne Schroeder, Koln (DE)

Correspondence Address: ROGER PITT;KIRKPATRICK & LOCKHART NICHOLSON GRAHAM LLP, 599 LEXINGTON AVENUE, 33RD FLOOR, NEW YORK, NY, 10022-6030, US

(21) Appl. No.: 11/197,279

(22) Filed: Aug. 4, 2005

Related U.S. Application Data
(63) Continuation-in-part of application No. 29/232,669, filed on Jun. 22, 2005.

(51) Int. Cl. A41D 31/00; A23G 1/50

(52) U.S. Cl. 2/1; 426/104

(57) ABSTRACT

A plurality of substantially flexible skeletal members disposed in the form of a portion of a garment fabric panel is disclosed. A plurality of connecting members secure the skeletal member in a configuration corresponding to the shape of the portion of the fabric panel. A plurality of candy members is disposed on the skeletal member. A plurality of knots may be employed in the skeletal members at least at some points between the candy members, whereby limited removal of the candy members may be implemented. A plurality of skeletal lengths may be implemented to provide limited removal of the candy members.

### CROSS REFERENCE TO RELATED APPLICATIONS

This application is a continuation in part of copending U. S. Design patent application Ser. No. 29/232,669 filed Jun. 22, 2005, naming Yvonne Schroeder as inventor for “UNDERWEAR”, the benefit of which is claimed. The entire disclosure of the aforesaid application is hereby incorporated herein by this specific reference thereto.

### TECHNICAL FIELD

The invention relates to edible items of clothing.

### BACKGROUND

The use of candy in garments and other items which might be worn by an individual is known. See, for example, U.S. Pat. No. 6,872,119 which shows a bikini and other garments incorporating hard candy string elements similar to hard candy necklaces. Such items are of interest for their attractive design, novelty appeal, and function as a flavorful food experience and nutritive supplement.

### SUMMARY OF THE INVENTION

The inventive garment comprises a plurality of substantially flexible skeletal members disposed in the form of a portion of a garment fabric panel. A plurality of connecting members secure the skeletal members in a configuration corresponding to the shape of the portion of the fabric panel. A plurality of candy members is disposed on the skeletal members.

The candy members may comprise hard candy. The candy members may be preferably disposed in a configuration to allow ventilation between said hard candy members.

Knots may be employed in the skeletal members at least at any some points between the candy members whereby limited removal of the candy members may be implemented. Such limited removal can also be achieved with the skeletal members being cross-linked.

The inventive garment may include skeletal members of various lengths, whereby limited removal of the candy members may be implemented.

The inventive garment may also further comprise a coating disposed over the candy members whereby the action of moisture is limited. Likewise a candy members may comprise an anti-stick filler material. The candy members may also comprise a compacted material.

So yet additional advantages are achieved with candy members which comprise a compacted xylitol.

### BRIEF DESCRIPTION OF THE DRAWINGS

The above aspects of the invention will be understood from the following description taken in conjunction with the drawings, in which:

FIG. 1 is a perspective view of a bikini bottom constructed in accordance with the present invention;

FIG. 2 is a plain view of the garment of FIG. 1 laid out on a table;

FIG. 3 is a perspective view of a bikini top or bra constructed in accordance with the present invention;

FIG. 4 is a plain view of the garment of FIG. 3 laid out on a table;

FIG. 5 is a front perspective view of a g-string constructed in accordance with the present invention; and

FIG. 6 is a rear perspective view of the garment of FIG. 5.

### DETAILED DESCRIPTION OF THE PREFERRED EMBODIMENT

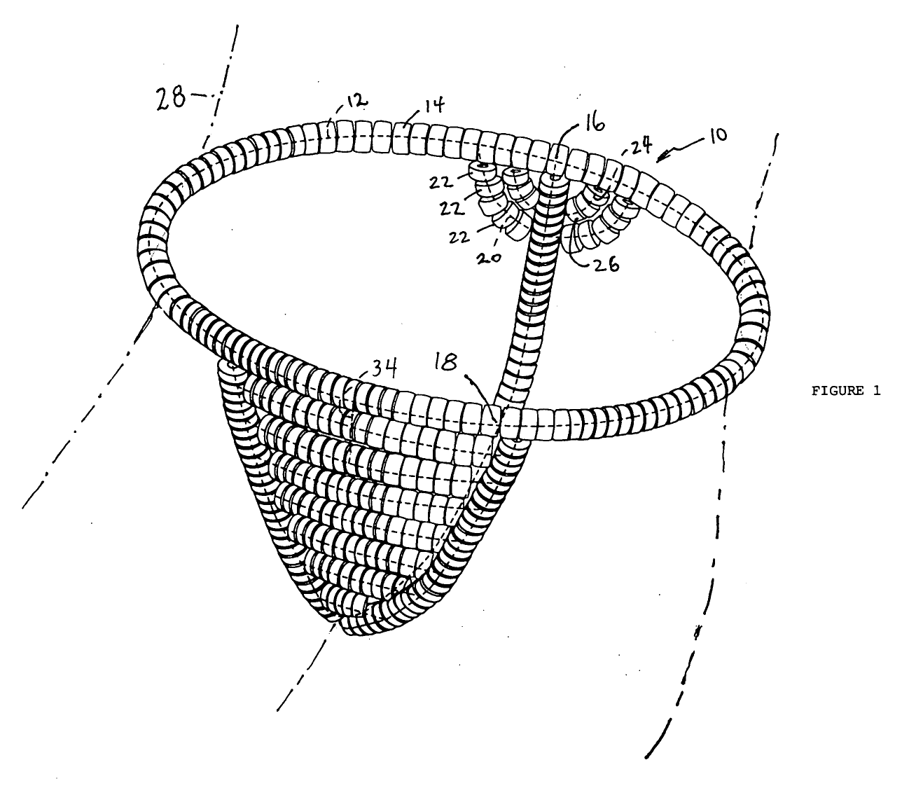

Referring to FIG. 1, a garment 10, in the illustrated example a bikini bottom or panty, comprises a plurality of the skeletal members which may be elastic, such as skeletal member 12 which support candy members such as candies 14. Skeletal members are joined connection points such as connection point 16 by, for example, knotting or the use of an adhesive. At other points, such as point 18, attachment may be achieved by twisting, as well as by knotting or the use of an adhesive.

If desired, knots in the skeletal members may be placed between individual candies 14 at all points between candies 14 or at only some points in order to provide for limited removal of hard candies.

The various skeletal members are of different lengths and thus accommodate the mounting of different numbers of candies 14. For example, skeletal member 20 supports five candies 22. Skeletal member 24 supports three candies 26. Accordingly, different numbers of candies may be released for consumption as food by breaking different skeletal members, leaving the remaining structure intact. In the case of knotted structures, any number of candies may be released.

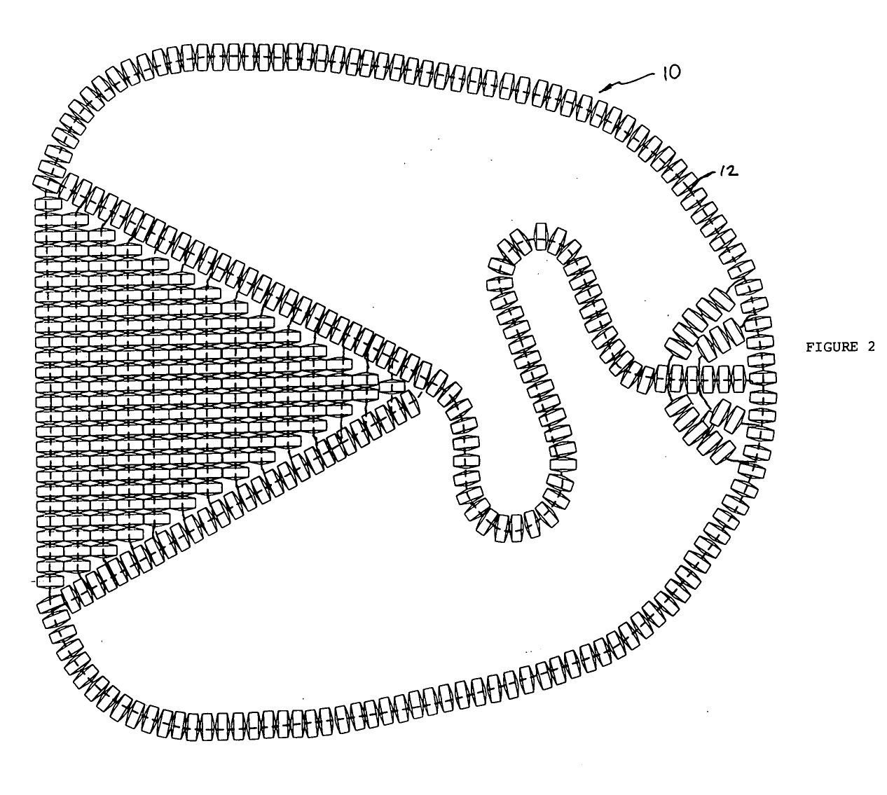

In accordance with the invention, it is contemplated that the garment will be worn in a conventional fashion by a user 28, as is illustrated in FIG. 1. FIG. 2 illustrates garment 10 as it would appear when placed, for example, on the top of a table.

In accordance with the invention, it is contemplated that numerous confections may be used to provide the candies 22. While old-fashioned hard candies comprising sugar mixed with flavoring and heated to the point where polymerization is so complete that the resulting product is rigid when cooled (in other words has become a hard candy), as opposed to a crystalline or a short chain polymer form such as caramel, other forms of candy are preferred.

More particularly, because the candies may be exposed to humidity released by the skin, in the case of a garment worn over another garment, or may be directly in contact with the skin, conventional sugar candies will tend to melt and become sticky. Accordingly, known techniques for manufacture of humidity resistant confectionery products, such as coating with sorbitol and/or other non-sugar sweeteners in or more layers, use of an adhesive or binder, or anti-stick filler materials (for example calcium carbonate) may be employed in accordance with the invention.

Accordingly, in a preferred embodiment of the invention, candies comprising compacted crystalline sugar, flavoring, binders (such as gum Arabic), gelatin, and corn syrup, such as those sold under the trademark Altoids are preferred to a conventional hard candy. Generally, long chain sugars such as those contained in certain grades of corn syrup, gelatin and similar materials will act to insulate the sugar in the candy from the action of moisture. Likewise, compacted crystalline sugars do not promote the absorption of moisture.

Nevertheless, other recipes known in the art of candymaking may provide superior results. For example, recipes for multilayered coated tablets comprising sugar, maltodextrin, tartaric acid, gum Arabic, rice starch, magnesium stearate, carnauba wax are even more impervious to degradation and stickiness as a result of exposure to moisture. Such recipes are used, for example, in candies marketed under the mark Tic Tac, which has a crystalline sugar core with a coating designed to inhibit degradation of the tablet on account of the action of moisture.

Still yet more effective are xylitol based recipes. Typically, such a product would comprise the xylitol, flavoring, magnesium stearate, silica dioxide and bee's wax, and, similarly would comprise a crystalline core with a coating. Xylitol based confectionery products employed in the garment of the present invention have the additional advantages of xylitol in preventing tooth decay.

The candies may also be made of a composition comprising dextrose, corn syrup, maltodextrin, magnesium stearate, citric acid, flavors, and colors. Such a recipe is desirably made of compacted granulated powdery materials and may include a coating.

The above advantages of moisture protection are enhanced by the structure of the inventive garments which have plentiful void spaces to promote evaporation of surface accumulations of moisture on the candies.

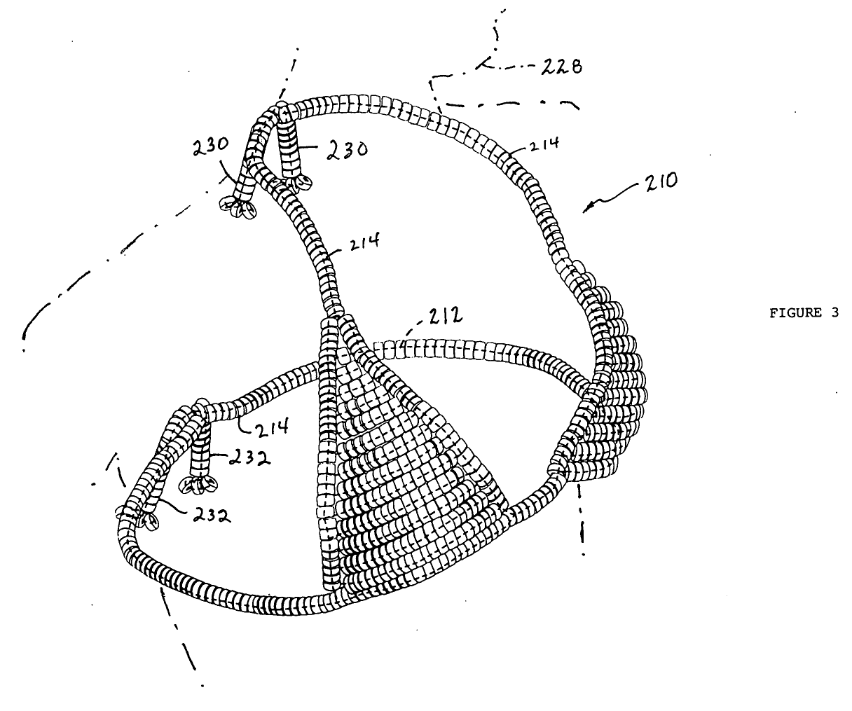

Referring to FIG. 3, a garment 210, in this case a bikini top, constructed in accordance with the present invention is illustrated being worn by a user 228. In the example illustrated in FIG. 3, the structure is similar to that of FIG. 1 except for the nature of the garment defined by the skeletal members 212 and the candies 214 which they support.

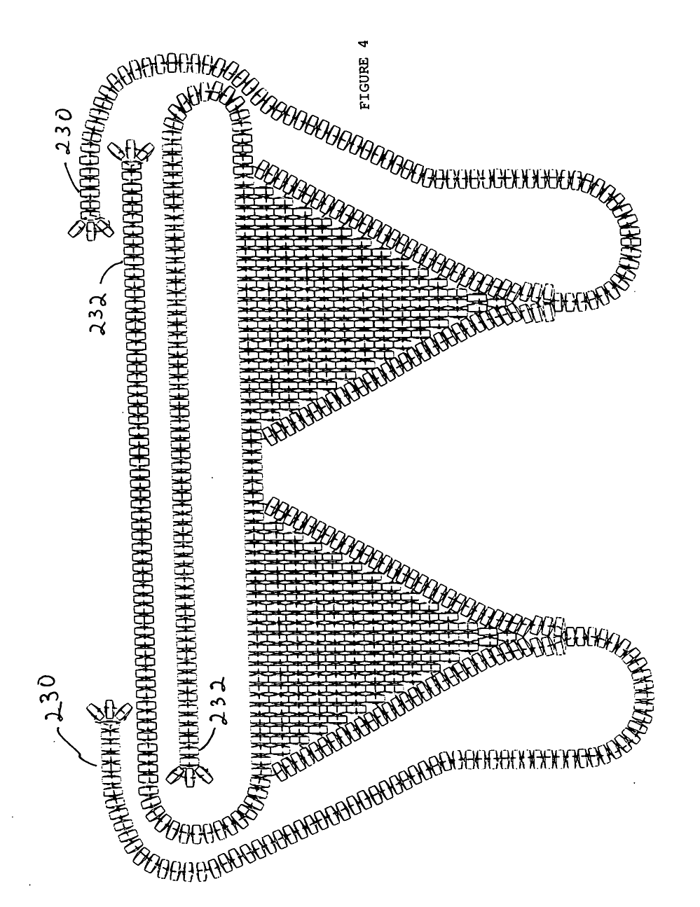

As illustrated in FIG. 4, garment 210 defines a pair of neck ends 230 which are placed behind the neck and tied as illustrated in FIG. 3. In similar fashion a pair of back strap ends 232 are placed over the back and tied as illustrated in FIG. 3.

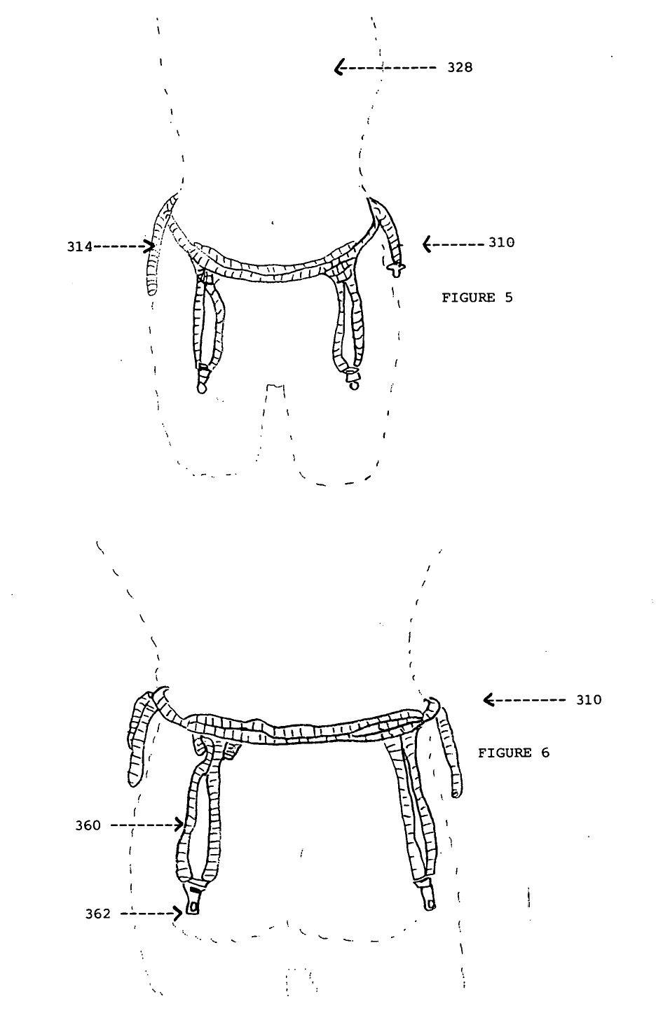

Referring to FIG. 5, a garment 310, in this case a g-string, constructed in accordance with the present invention is illustrated being worn by a user 328. In the example illustrated in FIG. 5, the structure is similar to that of FIG. 1 except for the nature of the garment defined by the skeletal members and the candies 314 which they support. As illustrated in FIGS. 5 and 6, garment 310 defines support straps 360 supporting snaps 362.

The inventive garments have been illustrated in a variety of configurations. It will be appreciated that other garments in other configurations may be employed in accordance with the invention. Likewise, other variations, such as the addition of cross-linking skeletal members may optionally be added, such as cross-linking skeletal member 34 in FIG. 1.

While illustrative embodiments of the invention have been described, it is, of course, understood that various modifications will be apparent in view of the above disclosure to those of ordinary skill in the yard. Such modifications are within the spirit and scope of the invention which is limited and defined only by the appended claims.

1. A garment, comprising:
(a) a plurality of substantially flexible skeletal members disposed in the form of a portion of a garment fabric panel;
(b) a plurality of connecting members securing said skeletal members in a configuration corresponding to said shape of said portion of said fabric panel;
(c) a plurality of candy members disposed on said skeletal members.

2. A garment as in claim 1, wherein said candy members comprise hard candy.

3. A garment as in claim 1, wherein said candy members are disposed in a configuration to allow ventilation between said hard candy members.

4. A garment as in claim 1, wherein knots in the skeletal members are provided at least at said some points between said candy members whereby limited removal of said candy members may be implemented.

5. A garment as in claim 1, wherein skeletal members are of various lengths, whereby limited removal of said candy members may be implemented.

6. A garment as in claim 1, further comprising a coating disposed over said candy members whereby the action of moisture is limited.

7. A garment as in claim 1, wherein said candy members comprise an anti-stick filler material.

8. A garment as in claim 1, wherein said candy members comprise a compacted material.

9. A garment as in claim 1, wherein said candy members comprise a compacted xylitol.

10. A garment as in claim 1, wherein said skeletal members are cross-linked.
